(19) United States
(12) Patent Application Publication
(10) Pub. No.: US 2019/0056996 A1
(43) Pub. Date: Feb. 21, 2019

(54) MANAGING UNAVAILABLE STORAGE IN A DISPERSED STORAGE NETWORK

(71) Applicant: International Business Machines Corporation, Armonk, NY (US)

(72) Inventors: Jason K. Resch, Chicago, IL (US); Wesley B. Leggette, Chicago, IL (US)

(21) Appl. No.: 16/166,437

(22) Filed: Oct. 22, 2018

Related U.S. Application Data
(63) Continuation-in-part of application No. 15/398,163, filed on Jan. 4, 2017.
Application No. 15/398,163 is a continuation of application No. 14/549,253, filed on Nov. 20, 2014, now Pat. No. 9,552,261.
(60) Provisional application No. 61/933,953, filed on Jan. 31, 2014.

(51) Int. Cl. G06F 11/10; G06F 11/14; G06F 3/06

(52) U.S. Cl. CPC G06F 11/1076; G06F 11/1088; G06F 11/1464; G06F 11/1092; G06F 2211/1028; G06F 3/067; G06F 3/0644; G06F 3/064; G06F 3/0619

(57) ABSTRACT

A method begins by a processing module of a dispersed storage network (DSN) identifying a data object of a group of data objects for storage in the DSN and determining micro slice encoding parameters for the encoding the data object. The method continues by identifying a set of distributed storage (DS) units for storing encoded micro slices (EMSs) and generating a set of meta-slices from the set of EMSs, followed by determining whether DS units are available to store the meta-slices, determining a mapping scheme for storing the set of EMSs and mapping each meta-slice associated with a DS unit available to store the EMSs. The method continues by transmitting each meta-slice associated with a DS unit available to store the EMSs and when certain DS units of are not available to store the EMSs, transmitting each meta-slice associated with a DS unit not available to the DS units available to store the EMSs.

This application claims priority pursuant to 35 U.S.C. § 120 as a continuation-in-part of U.S. Utility application Ser. No. 15/398,163, entitled “RECOVERING DATA FROM MICROSLICES IN A DISPERSED STORAGE NETWORK”, filed Jan. 4, 2017, which claims priority pursuant to 35 U.S.C. § 120 as a continuation of U.S. Utility application Ser. No. 14/549,253, entitled “RECOVERING DATA FROM MICROSLICES IN A DISPERSED STORAGE NETWORK”, filed Nov. 20, 2014, issued as U.S. Pat. No. 9,552,261 on Jan. 24, 2017, which claims priority pursuant to 35 U.S.C. § 119(e) to U.S. Provisional Application No. 61/933,953, entitled “IDENTIFYING SLICE ERRORS ASSOCIATED WITH A DISPERSED STORAGE NETWORK”, filed Jan. 31, 2014, all of which are hereby incorporated herein by reference in their entirety and made part of the present U.S. Utility patent application for all purposes.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

### Technical Field of the Invention

This invention relates generally to computer networks and more particularly to dispersing error encoded data.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9 is a schematic block diagram of a dispersed storage network (DSN) in accordance with the present invention;

FIG. 10 is a schematic block diagram of a dispersed storage network (DSN) in accordance with the present invention;

FIG. 11A is a schematic block diagram of a dispersed storage network (DSN) in accordance with the present invention; and

FIG. 11B is a flowchart illustrating another example of storing data in accordance with the present invention.

### DETAILED DESCRIPTION OF THE INVENTION

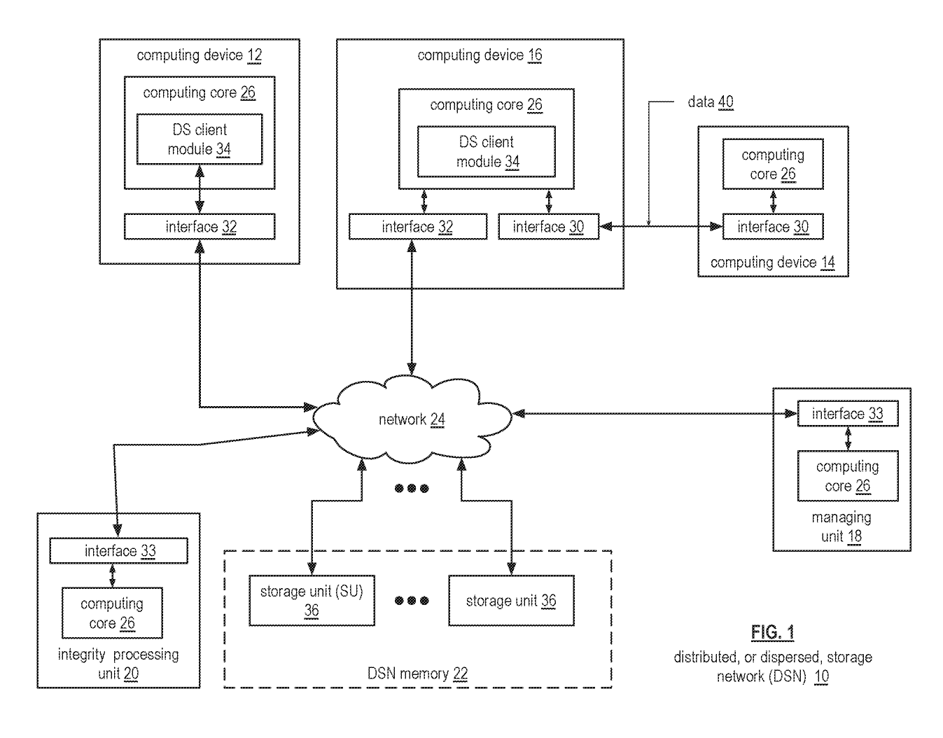

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

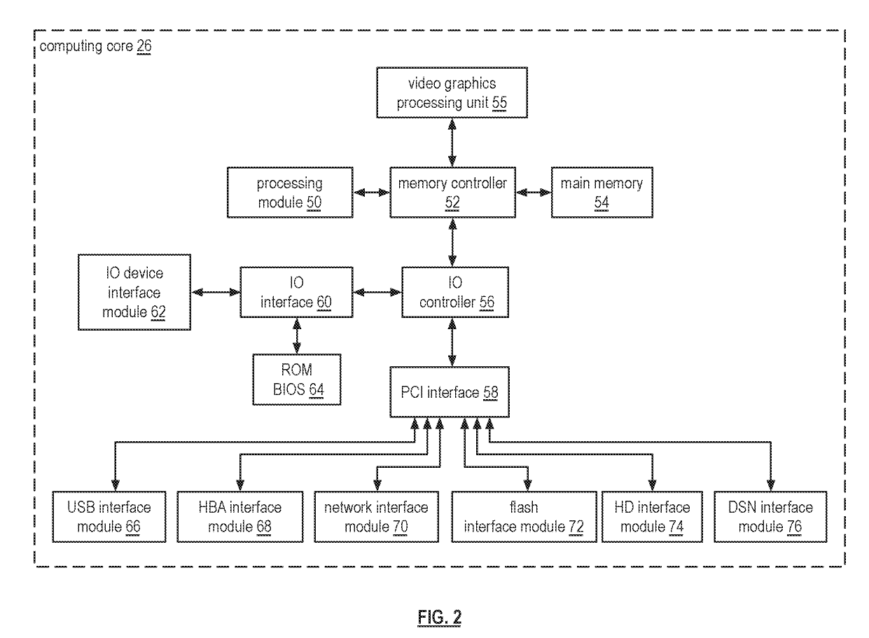

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 and 16 and the DSN memory 22. As yet another example, interface 33 supports a communication link for each of the managing unit 18 and the integrity processing unit 20 to the network 24.

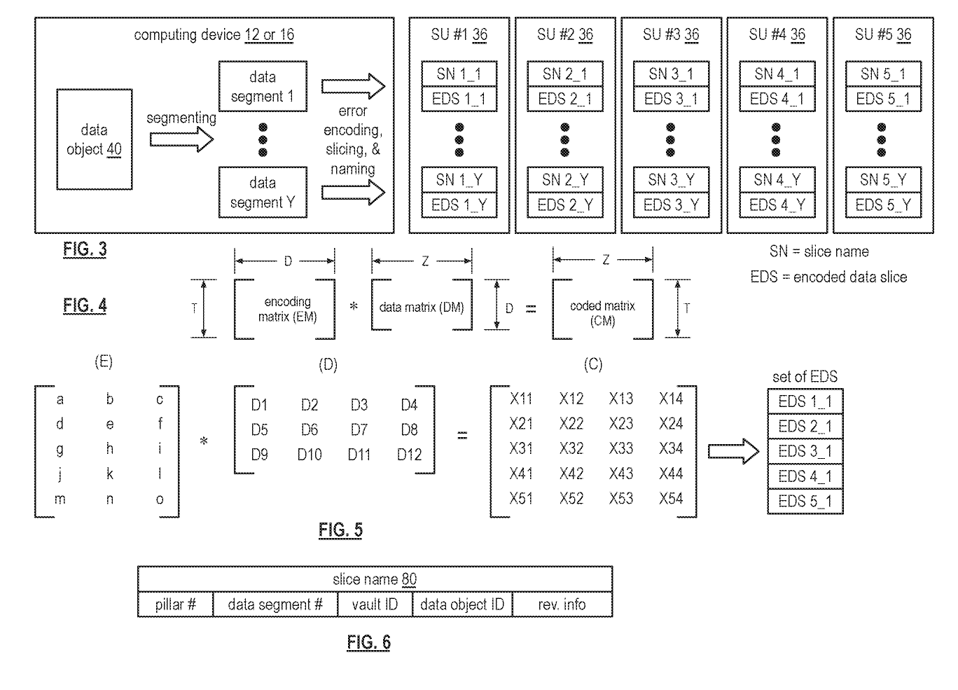

Computing devices 12 and 16 include a dispersed storage (DS) client module 34, which enables the computing device to dispersed storage error encode and decode data (e.g., data 40) as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The managing unit 18 creates billing information for a particular user, a user group, a vault access, public vault access, etc. For instance, the managing unit 18 tracks the number of times a user accesses a non-public vault and/or public vaults, which can be used to generate a per-access billing information. In another instance, the managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSN memory 22.

FIG. 2 is a schematic block diagram of an embodiment of a computing core 26 that includes a processing module 50, a memory controller 52, main memory 54, a video graphics processing unit 55, an input/output (TO) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment (i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

Returning to the discussion of FIG. 3, the computing device also creates a slice name (SN) for each encoded data slice (EDS) in the set of encoded data slices. A typical format for a slice name 80 is shown in FIG. 6. As shown, the slice name (SN) 80 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

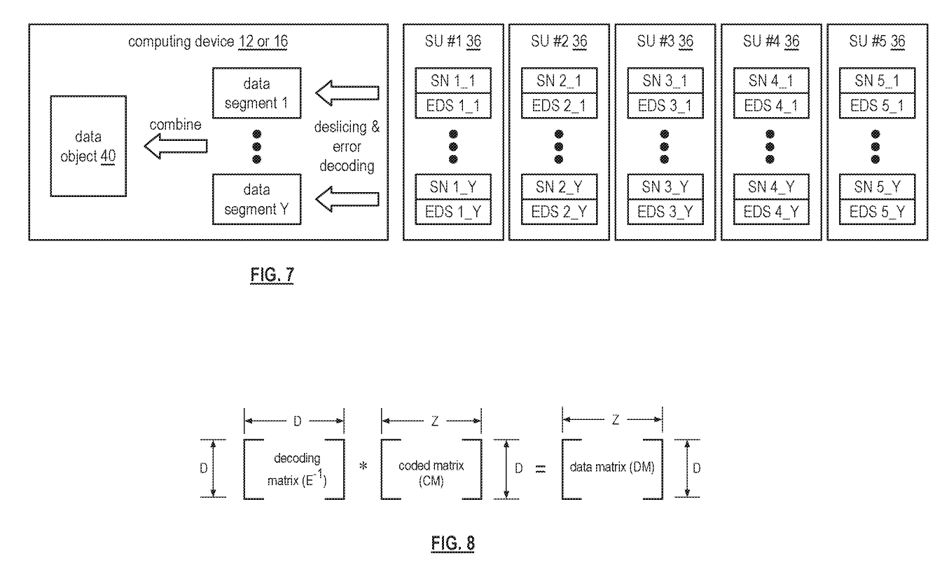

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

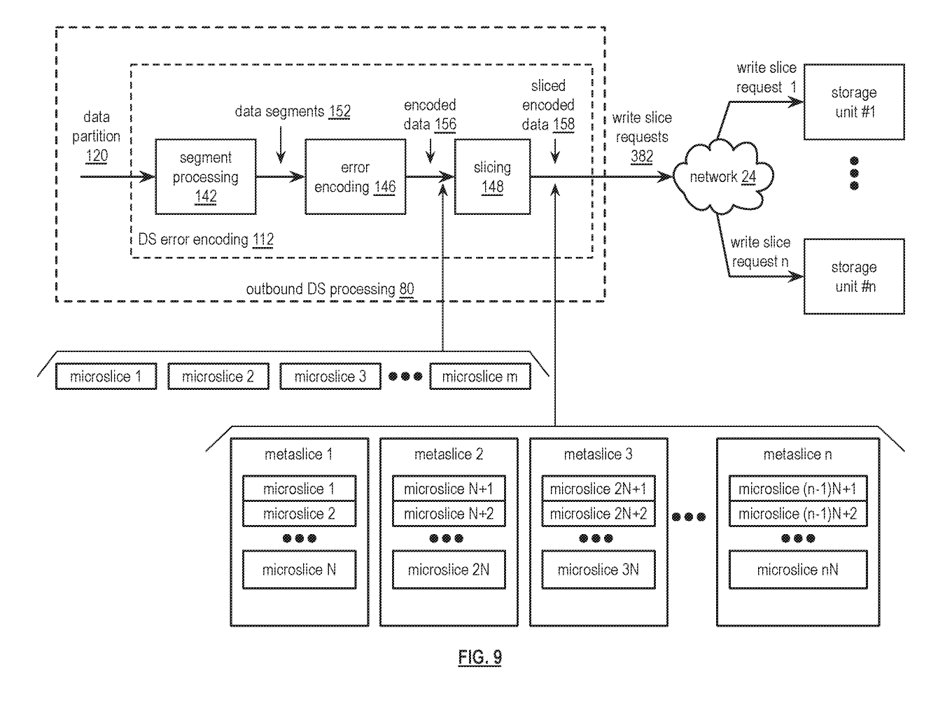

FIG. 9 is a schematic block diagram of a dispersed storage network (DSN) that includes an outbound distributed storage (DS) processing 80, the network 24 of FIG. 1, and a set of storage units 1-n. The DSN functions to store a data partition 120 as a set of encoded micro slices in the set of storage units 1-n.

In an example of operation, the segment processing 142 receives the data partition 120 for storage in a DSN vault associated with the DSN. Having received the data partition 120, the segment processing 142 outputs the data partition 120 as a data segment 152. Alternatively, the segment processing 142 divides the data partition 120 into two or more data segments 152 in accordance with a data segmentation scheme.

The error encoding 146 obtains encoding parameters that includes one or more of a micro slice width (m), a micro slice decode threshold, and an encoding matrix. As a specific example, the error encoding 146 accesses a system registry information to identify a vault identifier (ID) associated with the data partition and utilizes the vault ID to access a portion of the system registry information associated with the vault ID to retrieve the encoding parameters. As another specific example, the error encoding 146 determines the encoding parameters based on one or more of a performance goal and performance information. For instance, the error encoding 146 accesses the system registry to establish the micro slice width m=16,000 and the micro slice decode threshold as 10,000.

Having obtained the encoding parameters, the error encoding 146 encodes the data segment 152 using a dispersed storage error coding function in accordance with the encoding parameters to produce encoded data 156 that includes a set of encoded micro slices. As a specific example, the error encoding 146 encodes the data segment 152 to produce 16,000 encoded micro slices when the micro slice width is 16,000 (e.g., m=16,000). The error encoding 146 generates a micro slice width number of slice names for the corresponding set of encoded micro slices.

The slicing 148 identifies the set of storage units 1-n for storage of the encoded data 156 that includes the set of encoded micro slices (e.g., based on a table lookup). The slicing 148 determines dispersal parameters for slicing and storage of the set of encoded micro slices in the set of storage units 1-n. The dispersal parameters include one or more of a meta-slice width (n), a meta-slice decode threshold number, and a number of encoded micro slices per meta-slice (N). As a specific example, the slicing 148 determines the meta-slice width as the number of storage units n, the number of encoded micro slices per meta-slice (N) as N=micro slice width (m)/meta-slice width, and the meta-slice decode threshold number as the micro slice decode threshold number/N. For instance, the slicing 148 determines the meta-slice width as: n=16; the number of encoded micro slices per meta-slice: N=16,000/16=1,000; and the meta-slice decode threshold number as 10,000/1,000=10.

Having determined the dispersal parameters, the slicing 148 organizes the set of micro slices of the encoded data 156 to generate a set of meta-slices 1-n in accordance with the dispersal parameters (e.g., the meta-slice width number of data slices in the set of meta-slices and the number of micro slices per meta-slice N) to produce sliced encoded data 158. As a specific example, the slicing 148 generates each meta-slice to include 1,000 encoded micro slices of the set of 16,000 encoded micro slices when N=1,000. Alternatively, or in addition to, the slicing 148 generates a set of slice names for the set of meta-slices.

Having generated the sliced encoded data 158, the outbound DS processing 80 issues write slice requests (e.g., including write slice requests 1-n) to the set of storage units 1-n, where each write slice request includes one or more of a corresponding meta-slice of the set of meta-slices, a corresponding slice name of the meta-slice, and corresponding slice names associated with the encoded micro slices of the meta-slice.

Recovery of the data partition 120 from the set of storage units 1-n includes at least one of recovering a meta-slice decode threshold number of meta-slices and recovering a micro slice decode threshold number of encoded micro slices and decoding either of the decode threshold number of slices to reproduce the data partition 120.

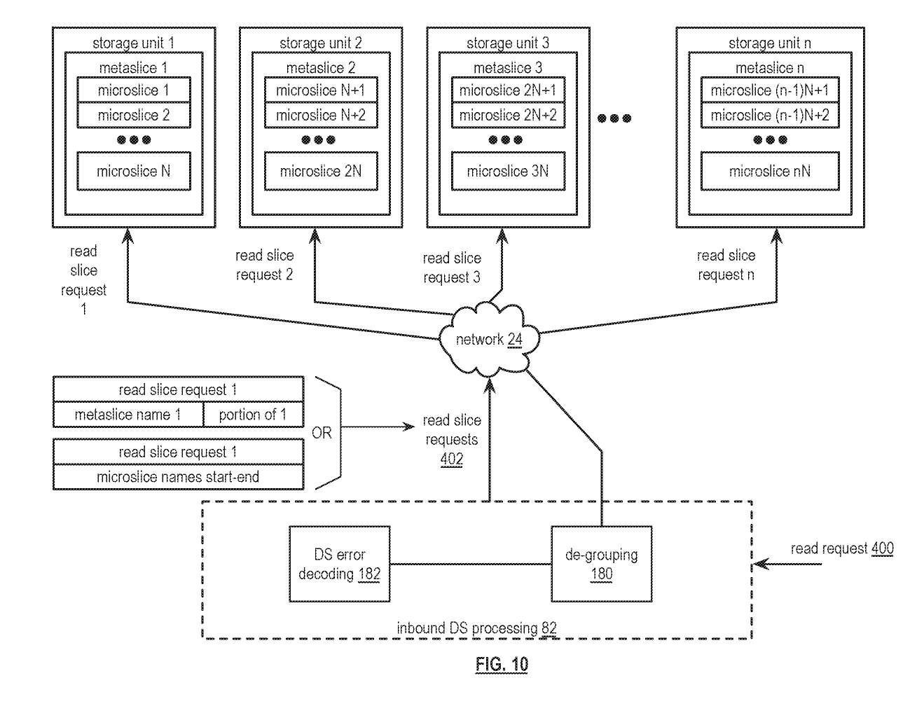

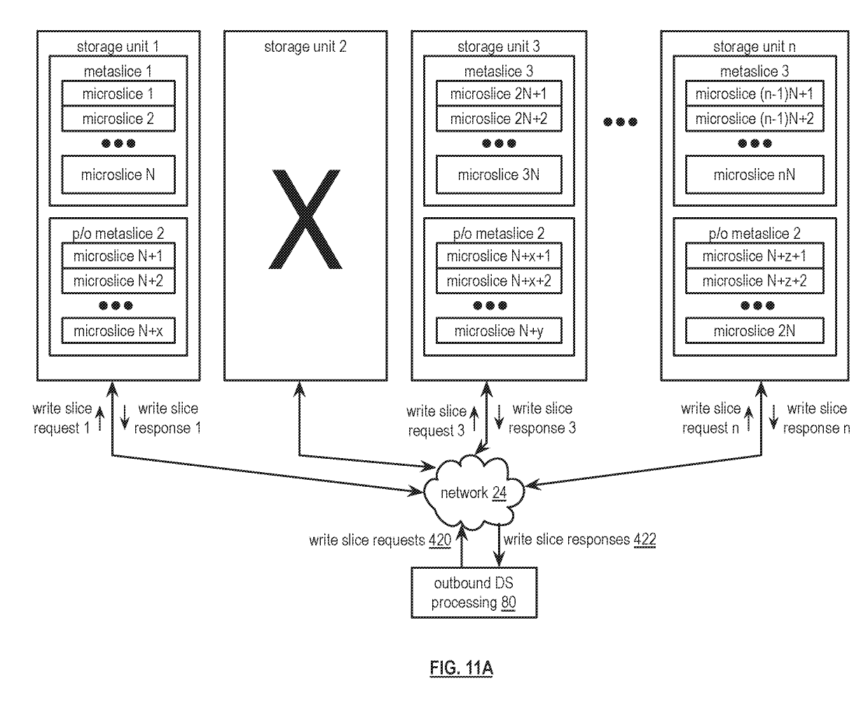

FIG. 10 is a schematic block diagram of a dispersed storage network (DSN) that includes the set of distributed storage units 1-n of FIG. 9, the network 24 of FIG. 1, and the inbound DS processing 82 of FIG. 3. The inbound DS processing 82 includes the dispersed storage (DS) error decoding 182 and the de-grouping 180 of FIG. 13. The DSN functions to recover a data partition 120 from a set of encoded micro slices stored in the set of storage units 1-n.

In an example of operation, the inbound DS processing 82 identifies data for retrieval from the set of storage units 1-n. The identifying includes at least one of determining an identifier of the data partition 120, receiving the identifier, and performing a lookup to retrieve the identifier. Having identified the data for retrieval, the inbound DS processing 82 identifies the set of storage units that stores the set of encoded micro slices of the data as a set of metadata slices. The identifying includes at least one of accessing a DSN directory, accessing a dispersed hierarchical index, performing a data identifier to DSN storage location table lookup, receiving a storage unit list, and retrieving the storage unit list.

Having identified the storage units, the inbound DS processing 82 determines retrieval performance information for the storage units. The retrieval performance information includes one or more of historical retrieval bandwidth, historical retrieval latency, historical retrieval availability, and historical retrieval reliability. The determining of the retrieval performance information includes at least one of initiating a test, interpreting test results, issuing a query, interpreting a query response, and receiving the retrieval performance information. As a specific example, the inbound DS processing 82 determines the retrieval performance information that indicates that storage unit 2 has three times the retrieval bandwidth capacity as compared to the other storage units.

Having determined the retrieval performance information, the inbound DS processing 82, for each storage unit, determines a number of encoded micro slices for retrieval based on the retrieval performance information and dispersal parameters (e.g., meta-slice width, meta-slice decode threshold number) utilized when the set of encoded micro slices were stored as the set of meta-slices. As a specific example, the inbound DS processing 82 determines to retrieve three times as many encoded micro slices from the higher performing storage unit 2 as compared to the other storage units. As another specific example, the inbound DS processing 82 determines to retrieve substantially an equal number of encoded micro slices of the set of encoded micro slices from each of the storage units. As yet another specific example, the inbound DS processing 82 determines to retrieve a total of 100% multiplied by the meta-slice decode threshold number (e.g., 100%×3 when the meta-slice decode threshold number is 3), where 100% of encoded micro slices stored at the storage unit 2 (e.g., higher performing unit) are selected, and 50% of encoded micro slices are selected (e.g., a remaining 200%=50%×4) from four other storage units when the number of storage units is 5 (e.g., the meta-slice width is 5). Alternatively, the determining of the number of encoded micro slices provided by each storage unit may be executed by one or more of the storage units.

Having determined the number of encoded micro slices for retrieval for each of the storage units, the inbound DS processing 82 issues read slice requests (e.g., including the slice requests 1-n) to the storage units in accordance with the number of encoded micro slices for retrieval from each storage unit. Each read slice request includes an indication of a desired portion of a metadata slice. For instance, the read slice request includes slice names of each encoded micro slice. As another instance, the read slice request includes a metadata slice name and a portion indicator (e.g., % of encoded micro slices of a corresponding metadata slice, a number of encoded micro slices of the metadata slice). As yet another instance, the read slice request includes a performance indicator for the storage unit with regards to a reference performance level (e.g., a performance level of a best-performing storage unit).

The de-grouping 180 receives read slice responses (e.g., from read slice responses 1-n from the storage units 1-n) that includes encoded micro slices. When receiving a micro slice decode threshold number of encoded micro slices, the de-grouping 180 outputs encoded slices per data partition 122 (e.g., the micro slice decode threshold number of encoded micro slices) to the DS error decoding 182. The DS error decoding 122 disperse storage error decodes the encoded slices per data partition 122 to reproduce the data partition 120.

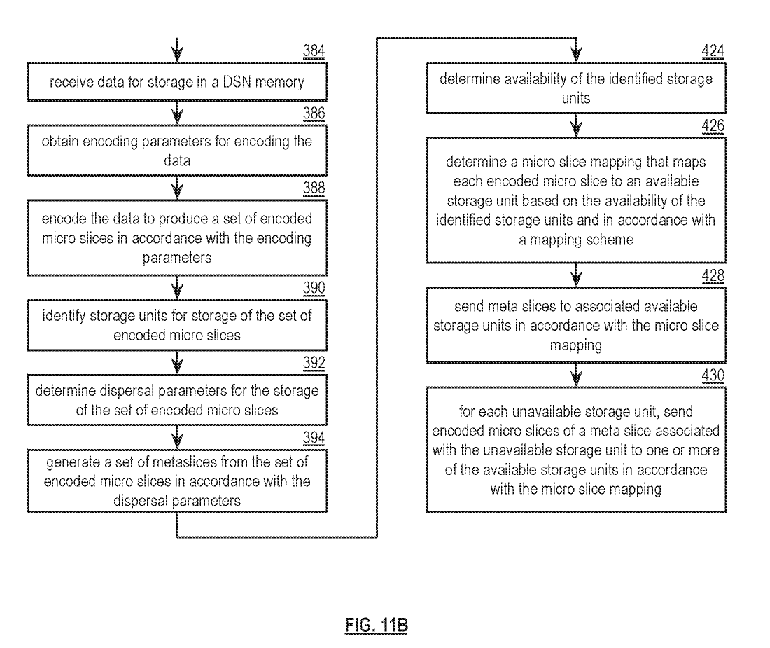

FIG. 11A is a schematic block diagram of a dispersed storage network (DSN) that includes the set of storage units 1-n of FIG. 10, the network 24 of FIG. 1, and the outbound DS processing 80 of FIG. 9. The DSN functions to store data as a set of encoded micro slices in the set of storage units 1-n.

In an example of operation, the outbound DS processing unit 80 receives the data for storage in a DSN vault associated with the DSN. Having received the data, the outbound DS processing 80 obtains encoding parameters that includes one or more of a micro slice width (m), a micro slice decode threshold, and an encoding matrix. As a specific example, the outbound DS processing 80 accesses system registry information to identify a vault identifier (ID) associated with the data partition and utilizes the vault ID to access a portion of the system registry information associated with the vault ID to retrieve the encoding parameters. As another specific example, the outbound DS processing 80 determines the encoding parameters based on one or more of a performance goal and performance information. For instance, the outbound DS processing 80 accesses the system registry to establish the micro slice width m=16,000 and the micro slice decode threshold as 10,000.

Having obtained the encoding parameters, the outbound DS processing 80 encodes the data using a dispersed storage error coding function in accordance with the encoding parameters to produce a set of encoded micro slices. As a specific example, the outbound DS processing 80 encodes the data to produce 16,000 encoded micro slices when the micro slice width is 16,000 (e.g., m=16,000). The outbound DS processing 80 generates a micro slice width number of slice names for the corresponding set of encoded micro slices.

The outbound DS processing 80 identifies the set of storage units 1-n for storage of the set of encoded micro slices (e.g., based on a table lookup). The outbound DS processing 80 determines dispersal parameters for slicing and storage of the set of encoded micro slices in the set of storage units 1-n. The dispersal parameters include one or more of a meta-slice width (n), a meta-slice decode threshold number, and a number of encoded micro slices per meta-slice (N). As a specific example, the outbound DS processing 80 determines the meta-slice width as the number of storage units n, the number of encoded micro slices per meta-slice (N) as N=micro slice width (m)/meta-slice width, and the meta-slice decode threshold number as the micro slice decode threshold number/N. For instance, the outbound DS processing 80 determines the meta-slice width as: n=16; the number of encoded micro slices per meta-slice: N=16,000/16=1,000; and the meta-slice decode threshold number as 10,000/1,000=10.

Having determined the dispersal parameters, the outbound DS processing 80 organizes the set of micro slices of the encoded data 156 to generate a set of meta-slices 1-n in accordance with the dispersal parameters (e.g., the meta-slice width number of data slices in the set of meta-slices and the number of micro slices per meta-slice N). As a specific example, the outbound DS processing 80 generates each meta-slice to include 1,000 encoded micro slices of the set of 16,000 encoded micro slices when N=1,000. Alternatively, or in addition to, the outbound DS processing 80 generates a set of slice names for the set of meta-slices.

Having generated the set of data slices, the outbound DS processing 80 determines availability of the identified set of storage units. The availability indicates whether a corresponding storage unit is available or not available (e.g., off-line for maintenance, powered down, destroyed, without network connectivity, etc.). The determining includes at least one of issuing a write slice request and determining whether a corresponding write slice response received within a response timeframe; initiating an availability poll and determining whether a corresponding availability poll response has been received within a poll response timeframe; and interpreting a list of available storage units.

Having determined the availability of the identified set of storage units, the outbound DS processing 80 determines a micro slice mapping that maps each encoded micro slice to unavailable storage unit based on the availability of the identified set of storage units and a mapping scheme. The mapping scheme includes at least one of assigning encoded micro slices associated with unavailable storage unit to one or more other storage units based on performance level information, evenly mapping micro slices of a meta-slice associated with unavailable storage unit two other available storage units, encoding micro slices of a common pillar to unavailable storage unit associated with the common pillar. The outbound DS processing 80 may select the mapping scheme based on one or more of a request, a vault identifier, a predetermination, a performance goal, and performance of the set of storage units.

Having determined the micro slice mapping, the outbound DS processing 80 sends the encoded micro slices to available storage units in accordance with the micro slice mapping. As a specific example, the outbound DS processing 80 issues write slice requests to the available storage units, where the write slice requests include encoded micro slices and slice names of the encoded micro slices. For instance, when the outbound DS processing 80 determines that storage unit 2 is unavailable, the outbound DS processing 80 evenly distributes encoded micro slices associated with storage unit 2 to the other storage units by including the encoded micro slices associated with the storage unit 2 in the write slice requests sent to the other storage units. Alternatively, or in addition to, the outbound DS processing 80 associates the slice names of the encoded micro slices associated with the storage unit 2 with the other storage units within at least one of a DSN directory and a dispersed hierarchical index.

FIG. 11B is a flowchart illustrating another example of storing data. The method begins at step 384 with a client module receiving data for storage in a dispersed storage network (DSN) memory, obtaining encoding parameters for encoding the data at step 386, encoding the data to produce a set of encoded micro slices in accordance with the encoding parameters at step 388, identifying storage units for storage of the set of encoded micro slices at step 390, determining dispersal parameters for the storage of the set of encoded micro slices at step 392, and generating a set of meta-slices from the set of encoded micro slices in accordance with the dispersal parameters at step 394. The method continues at the step 424 where the processing module determines availability of the identified storage units. The determining includes at least one of interpreting an error message, initiating a query, interpreting a query response, initiating a test, and interpreting a test result.

The method continues at the step 426 where the processing module determines a micro slice mapping that maps each encoded micro slice to unavailable storage unit based on the availability of the identified storage units and in accordance with a mapping scheme at step 426. The determining may be based on one or more of selecting a mapping scheme based on one or more of an input, a predetermination, a system registry entry, a network performance level indicator, and a storage unit performance level indicator.

The method continues at the step 428 where the processing module sends meta-slices to associated available storage units in accordance with the micro slice mapping. As a specific example, the processing module generates and sends write slice requests to each of the storage units, where each write slice request includes a group of encoded micro slices in accordance with the micro slice mapping.

For each unavailable storage unit, encoded micro slices of a meta-slice associated with the unavailable storage unit are sent to one or more of the available storage units in accordance with the micro slice mapping at step 430. The sending includes issuing write slice requests to the one or more of the available storage units. As an example, the processing module sends one write slice request to unavailable storage unit where the write slice request includes micro slices associated with the available storage unit and at least some micro slices associated with the unavailable storage unit.

Alternatively, the processing module maps the meta-slice of the unavailable storage unit two one of the other available storage units. Further alternatively, when the unavailable storage unit becomes available, the processing module facilitates migration of associated encoded micro slices to the now available storage unit.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for execution by one or more processing modules of one or more computing devices of a dispersed storage network (DSN), the method comprises:
identifying a data object of a group of data objects for storage in the DSN;
determining micro slice encoding parameters for the encoding the data object, wherein the data object is segmented into a plurality of data segments, wherein a data segment is encoded into a plurality of encoded micro slices in accordance with micro slice encoding parameters, wherein a micro slice decode threshold number of encoded micro slices of the plurality of encoded micro slices is needed to recover the data segment;
dispersed storage error encoding the data segment into a set of encoded micro slices in accordance with micro slice encoding parameters;
identifying a set of distributed storage (DS) units for storing the set of encoded micro slices;
generating a set of meta-slices from the set of encoded micro slices, wherein each meta-slice is generated according to dispersal parameters;
determining whether one or more DS units of the set of DS units is available to store each meta-slice of the set of meta-slices;
determining a mapping scheme for storing the set of encoded micro slices;
mapping each meta-slice associated with a DS unit available to store the encoded micro slices of the set of encoded micro slices in accordance with the mapping scheme;
transmitting each meta-slice associated with a DS unit available to store the encoded micro slices of the set of encoded micro slices to the one or more DS units of the set of DS units that are available to store the encoded micro slices; and
in response to determining that one or more DS units of the set of DS units is not available to store the encoded micro slices, transmitting each meta-slice associated with a DS unit not available to store the encoded micro slices of the set of encoded micro slices to one of the DS units available to store the encoded micro slices of the set of encoded micro slices.

2. The method of claim 1, wherein the identifying a data object of a group of data objects for storage in the DSN comprises:
receiving a read request for the data segment.

3. The method of claim 1, wherein the determining whether one or more DS units of the set of DS units is available to store each meta-slice of the set of meta-slices comprises at least one of:
interpreting an error message, initiating a query, interpreting a query response, initiating a test and interpreting a test result.

4. The method of claim 1 wherein the determining a mapping scheme for storing the set of encoded micro slices is based on at least one of:
a predetermination, a system registry entry, a network performance level indicator and a storage unit performance level indicator.

5. The method of claim 1, wherein the transmitting each meta-slice associated with a DS unit available to store the encoded micro slices of the set of encoded micro slices to the one or more DS units of the set of DS units that are available includes generating and sending write slice requests to each of the storage units, wherein each write slice request includes a group of encoded micro slices in accordance with the micro slice mapping.

6. The method of claim 1, wherein the transmitting each meta-slice associated with a DS unit not available to store the encoded micro slices of the set of encoded micro slices to one of the DS units available to store the encoded micro slices of the set of encoded micro slices includes issuing one or more write slice requests to the one or more available storage units.

7. The method of claim 1, wherein the transmitting each meta-slice associated with a DS unit not available to store the encoded micro slices of the set of encoded micro slices to one of the DS units available to store the encoded micro slices of the set of encoded micro slices includes mapping the meta-slice of the DS unit not available to the one or more DS units of the set of DS units that are available to store the encoded micro slices.

8. The method of claim 1 further comprising:
after transmitting each meta-slice associated with a DS unit that is unavailable to store the encoded micro slices of the set of encoded micro slices to one of the DS units that is available to store the encoded micro slices of the set of encoded micro slices, determining whether a DS unit that was previously unavailable to store the encoded micro slices of the set of encoded micro slices has become available; and
based on a determination that the DS unit that is unavailable to store the encoded micro slices of the set of encoded micro slices has become available, facilitating migration of one or more meta-slices from the one of the DS units that is available to store the encoded micro slices of the set of encoded micro slices to the DS unit that was previously unavailable to store the encoded micro slices of the set of encoded micro slices and that has become available.

9. A computer readable memory device comprises:
at least one memory section that stores operational instructions that, when executed by one or more processing modules of one or more computing devices of a dispersed storage network (DSN), causes the one or more computing devices to:
identify a data object of a group of data objects for storage in the DSN;
determine micro slice encoding parameters for the encoding the data object, wherein the data object is segmented into a plurality of data segments, wherein a data segment is encoded into a plurality of encoded micro slices in accordance with micro slice encoding parameters, wherein a micro slice decode threshold number of encoded micro slices of the plurality of encoded micro slices is needed to recover the data segment;
dispersed storage error encode the data segment into a set of encoded micro slices in accordance with micro slice encoding parameters;
identify a set of distributed storage (DS) units for storing the set of encoded micro slices;
generate a set of meta-slices from the set of encoded micro slices, wherein each meta-slice is generated according to dispersal parameters;
determine whether one or more DS units of the set of DS units is available to store each meta-slice of the set of meta-slices;
determine a mapping scheme for storing the set of encoded micro slices;
map each meta-slice associated with a DS unit available to store the encoded micro slices of the set of encoded micro slices in accordance with the mapping scheme;
transmit each meta-slice associated with a DS unit available to store the encoded micro slices of the set of encoded micro slices to the one or more DS units of the set of DS units that are available to store the encoded micro slices; and
in response to a determination that one or more DS units of the set of DS units is not available to store the encoded micro slices, transmit each meta-slice associated with a DS unit not available to store the encoded micro slices of the set of encoded micro slices to one of the DS units available to store the encoded micro slices of the set of encoded micro slices.

10. The computer readable memory device of claim 9, wherein the at least one memory section stores operational instructions that, when executed by one or more processing modules of one or more computing devices of a dispersed storage network (DSN), causes the one or more computing devices to:
identify a data object of a group of data objects for storage in the DSN based on receipt of a write request for the data object.

11. The computer readable memory device of claim 9, wherein the at least one memory section stores operational instructions that, when executed by one or more processing modules of one or more computing devices of a dispersed storage network (DSN), causes the one or more computing devices to:
determine whether one or more DS units of the set of DS units is available to store each meta-slice of the set of meta-slices based on at least one of an error message interpretation, a query, a query response initiation interpretation, a test initiation and a test result interpretation.

12. The computer readable memory device of claim 9, wherein the at least one memory section stores operational instructions that, when executed by one or more processing modules of one or more computing devices of a dispersed storage network (DSN), causes the one or more computing devices to:
determine a mapping scheme for storing the set of encoded micro slices is based on at least one of a predetermination, a system registry entry, a network performance level indicator and a storage unit performance level indicator.

13. The computer readable memory device of claim 9, wherein the at least one memory section stores operational instructions that, when executed by one or more processing modules of one or more computing devices of a dispersed storage network (DSN), causes the one or more computing devices to:
transmit each meta-slice associated with a DS unit available to store the encoded micro slices of the set of encoded micro slices to the one or more DS units of the set of DS units that are available by generating and sending write slice requests to each of the storage units, wherein each write slice request includes a group of encoded micro slices in accordance with the micro slice mapping.

14. The computer readable memory device of claim 9, wherein the at least one memory section stores operational instructions that, when executed by one or more processing modules of one or more computing devices of a dispersed storage network (DSN), causes the one or more computing devices to:
transmit each meta-slice associated with a DS unit available to store the encoded micro slices of the set of encoded micro slices to the one or more DS units of the set of DS units that are available by generating and sending write slice requests to each of the storage units, wherein each write slice request includes a group of encoded micro slices in accordance with the micro slice mapping.

15. The computer readable memory device of claim 9, wherein the at least one memory section stores operational instructions that, when executed by one or more processing modules of one or more computing devices of a dispersed storage network (DSN), causes the one or more computing devices to:
transmit each meta-slice associated with a DS unit not available to store the encoded micro slices of the set of encoded micro slices to one of the DS units available to store the encoded micro slices of the set of encoded micro slices by issuing one or more write slice requests to the one or more DS units of the set of DS units that are available to store the encoded micro slices.

16. The computer readable memory device of claim 9 further comprises:
the at least one memory section stores further operational instructions that, when executed by the one or more processing modules, causes the one or more computing devices of the DSN to:
transmit each meta-slice associated with a DS unit not available to store the encoded micro slices of the set of encoded micro slices to one of the DS units available to store the encoded micro slices of the set of encoded micro slices by mapping the meta-slice of the DS unit not available to one of the other available storage units.

17. The computer readable memory device of claim 9 further comprises:
the at least one memory section stores further operational instructions that, when executed by the one or more processing modules, causes the one or more computing devices of the DSN to:
after transmitting each meta-slice associated with a DS unit that is unavailable to store the encoded micro slices of the set of encoded micro slices to one of the DS units that is available to store the encoded micro slices of the set of encoded micro slices, determining whether a DS unit that was previously unavailable to store the encoded micro slices of the set of encoded micro slices has become available; and
based on a determination that the DS unit that is unavailable to store the encoded micro slices of the set of encoded micro slices has become available, facilitating migration of one or more meta-slices from the one of the DS units that is available to store the encoded micro slices of the set of encoded micro slices to the DS unit that was previously unavailable to store the encoded micro slices of the set of encoded micro slices and that has become available.

18. A computing device of a group of computing devices of a dispersed storage network (DSN), the computing device comprises:
an interface;
a local memory; and
a processing module operably coupled to the interface and the local memory, wherein the processing module functions to:
identify a data object of a group of data objects for storage in the DSN;
determine micro slice encoding parameters for the encoding the data object, wherein the data object is segmented into a plurality of data segments, wherein a data segment is encoded into a plurality of encoded micro slices in accordance with micro slice encoding parameters, wherein a micro slice decode threshold number of encoded micro slices of the plurality of encoded micro slices is needed to recover the data segment;
dispersed storage error encode the data segment into a set of encoded micro slices in accordance with micro slice encoding parameters;
identify a set of distributed storage (DS) units for storing the set of encoded micro slices;
generate a set of meta-slices from the set of encoded micro slices, wherein each meta-slice is generated according to dispersal parameters;
determine whether one or more DS units of the set of DS units is available to store each meta-slice of the set of meta-slices;
determine a mapping scheme for storing the set of encoded micro slices;
map each meta-slice associated with a DS unit available to store the encoded micro slices of the set of encoded micro slices in accordance with the mapping scheme;
transmit each meta-slice associated with a DS unit available to store the encoded micro slices of the set of encoded micro slices to the one or more DS units of the set of DS units that are available to store the encoded micro slices; and
in response to a determination that one or more DS units of the set of DS units is not available to store the encoded micro slices, transmit each meta-slice associated with a DS unit not available to store the encoded micro slices of the set of encoded micro slices to one of the DS units available to store the encoded micro slices of the set of encoded micro slices.

19. The computing device of claim 18, wherein the processing module functions to determine whether one or more DS units of the set of DS units is available to store each meta-slice of the set of meta-slices based on at least one of an error message interpretation, a query, a query response initiation interpretation, a test initiation and a test result interpretation.

20. The computing device of claim 18, wherein the processing module functions to determine a mapping scheme for storing the set of encoded micro slices is based on at least one of a predetermination, a system registry entry, a network performance level indicator and a storage unit performance level indicator.
